(19) United States
(12) Patent Application Publication
(10) Pub. No.: US 2016/0239191 A1
(43) Pub. Date: Aug. 18, 2016

(54) MANIPULATION OF CONTENT ITEMS

(71) Applicant: Microsoft Technology Licensing, LLC, Redmond, WA (US)

(72) Inventor: Suresh Krishnasamy, Cambridge (GB)

(21) Appl. No.: 14/657,890

(22) Filed: Mar. 13, 2015

(30) Foreign Application Priority Data
Feb. 13, 2015 (CN) PCT/CN2015/073024

(51) Int. Cl. G06F 3/0484; G06F 3/0488

(52) U.S. Cl. CPC G06F 3/04847; G06F 3/04842; G06F 3/04883

(57) ABSTRACT

According to one embodiment of the subject matter disclosed herein, there is provided a method for facilitating manipulation of content items. The method comprises detecting user input for selecting a plurality of content items, and determining the selection direction in which the plurality of content items are selected. According to the method, if the determined selection direction satisfies a predefined criterion, a tool bar window can be popped up to facilitate manipulation of the selected content items. The tool bar window contains at least one functional item for manipulating the selected plurality of content items. A user may activate an operation or launch an application to manipulate the selected content items, by directly selecting a corresponding functional item contained in the tool bar window. In this way, the user is allowed to manipulate the selected content items more conveniently and efficiently.

### RELATED APPLICATIONS

This application claims priority to International Application No. PCT/CN2015/073024, filed on Feb. 13, 2015, and entitled “MANIPULATION OF CONTENT ITEMS.” This application claims the benefit of the above-identified application, and the disclosure of the above-identified application is hereby incorporated by reference in its entirety as if set forth herein in full.

### BACKGROUND

The following description of background art may include insights, discoveries, understandings or disclosures, or associations together with disclosures not known to the relevant art prior to the present disclosure but provided by the present disclosure. Some such contributions of the present disclosure may be specifically pointed out below, while other such contributions of the present disclosure will be apparent from their context.

Electronic devices using Graphical User Interfaces (GUIs) have become widely used. For example, these types of electronic devices include information processing devices such as music players, mobile telephones, tablets, small mobile terminal devices, personal computers, digital cameras with information processing functions. GUIs allow users to manage and manipulate content items more intuitively and conveniently. Here, content items may include pieces of text content (for example, characters, words, phrases or wordings), images, calendar entries, notification events, virtual representations of contents (for example, icons or thumbnails), any other selectable and operable elements rendered in a GUI, and any combinations thereof.

In a conventional GUI, a user can select one content item using a pointing device (e.g., a mouse or trackball cursor, or a stylus or finger on a touch-sensitive display). While the content item is selected, the user can initiate a desired operation (e.g., copy or paste) on it by selecting a corresponding functional item (e.g., functional button, functional icon). However, it may be not easy to perform operations, especially when the user wants to manipulate a plurality of content items with a particular application. For example, when the user wants to edit a plurality of content items obtained from an external content source, the user is normally required to locally save those content items, launch a corresponding editor application, open or insert the content items one by one using the editor application and then make modifications. The user may be unable to efficiently manipulate the content items, particularly when using an electronic device with a small size touch screen.

### SUMMARY

The following presents a simplified summary of the present disclosure in order to provide a basic understanding of some aspects of the present disclosure. It should be noted that this summary is not an extensive overview of the present disclosure and that it is not intended to identify key/critical elements of the present disclosure or to delineate the scope of the present disclosure. Its sole purpose is to present some concepts of the present disclosure in a simplified form as a prelude to the more detailed description that is presented later.

According to an aspect of the present disclosure, there is provided a method for facilitating manipulation of content items. According to one embodiment of the subject matter as described herein, a user input for selecting a plurality of content items is detected, and the selection direction in which the plurality of content items are selected is determined. If the determined selection direction satisfies a predefined criterion, a tool bar window can be popped up to facilitate manipulation of the selected content items. The tool bar window contains at least one functional item for manipulating the selected plurality of content items. A user may activate an operation or launch an application by directly selecting a corresponding functional item contained in the tool bar window. In various embodiments of the subject matter described herein, the user input may include a series of clicks for selecting the plurality of content items, movement of a pointing device, a user gesture for selecting the plurality of content items, content selection with any key combinations of keyboard/keypad and any suitable user input that is characterized by its directional feature. In one embodiment, the predefined criterion for the selection direction may be any suitable combination of one or more of the following criteria: the selection direction is from right to left; the selection direction is from bottom to top; the selection direction is in a predefined angle with a horizontal axis or a vertical axis; the selection direction is clockwise; the selection direction is anticlockwise; the selection direction is substantially consistent with a direction of a predefined curve.

When the user makes selections of the content items in a predefined selection direction, a popup tool bar window may be presented, which contains functional items associated with the potential operations that could be applied to the selected content items. In this way, the user is allowed to manipulate the selected content items more conveniently and efficiently.

This Summary is provided to introduce a selection of concepts in a simplified form. The concepts are further described below in the Detailed Description. This Summary is not intended to identify key features or essential features of the claimed subject matters, nor is it intended to be used to limit the scope of the claimed subject matters.

### BRIEF DESCRIPTION OF THE DRAWINGS

Embodiments of the subject matter described herein are illustrated by way of example and not limited in the accompanying figures in which like reference numerals indicate similar elements and in which:

FIG. 1 illustrates a flowchart of a method for facilitating manipulation of content items in accordance with one or more embodiments of the subject matter described herein;

FIGS. 2a-2c illustrate schematic diagrams showing a user interface in accordance with one embodiment of the subject matter described herein;

FIGS. 3a-3c illustrate schematic diagrams showing a user interface in accordance with another embodiment of the subject matter described herein;

FIGS. 4a-4c illustrate schematic diagrams showing a user interface in accordance with another embodiment of the subject matter described herein; and

FIG. 5 illustrates a block diagram of a device in accordance with one embodiment of the subject matter described herein.

### DETAILED DESCRIPTION

The present disclosure will now be described in more detailed manner hereinafter with reference to the accompanying drawings, in which certain embodiments of the present disclosure are shown. This disclosure may, however, be embodied in many different forms and should not be construed as limited to the embodiments set forth herein; rather, these embodiments are provided by way of example so that this disclosure will be thorough and complete, and will fully convey the scope of the present disclosure to those skilled in the art. Like numbers refer to like elements throughout the specification.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. The discussion above and below in respect of any of the aspects of the present disclosure is also in applicable parts relevant to any other aspect of the present disclosure.

As used herein, the term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

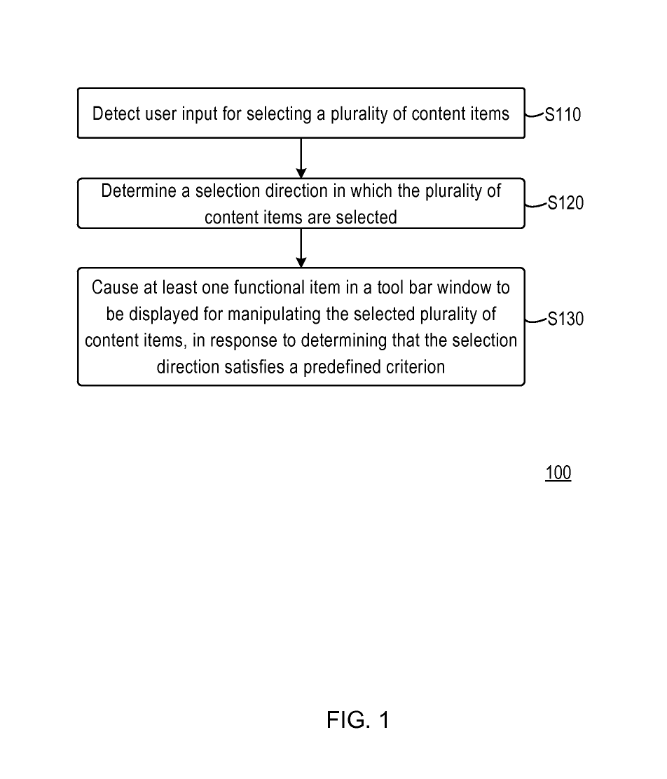

FIG. 1 illustrates a flowchart of a method 100 for facilitating manipulation of content items in accordance with one or more embodiments of the subject matter described herein.

As illustrated in FIG. 1, at S110, a user input is detected for selecting a plurality of content items. The term “content items” as used herein may refer to pieces of text content (for example, characters, words, phrases or wordings), images, voice files, video clips, calendar entries, notification events, virtual representations of contents (for example, icons, thumbnails), any other selectable and operable user interface elements rendered in a GUI, and any combinations thereof.

As known to those skilled in the art, a user may select content items by using a suitable pointing device. The term “pointing device” as used herein may refer to a keyboard/keypad, a mouse, a trackball, a joystick, a roller, or a stylus or finger on a touch-sensitive display. In one example embodiment, the selection input may be performed by directly touching the touch-sensitive display. Alternatively or additionally, in another example embodiment, operations such as inputting and selecting may be performed by moving a pointing device such as a finger or a stylus near a touch-sensitive display without a physical contact. In a further example embodiment, an electronic device may capture the user input performed on a projected GUI image by means of any suitable sensing means. Further examples of the technologies for detecting the user input may include, but are not limited to, eye movement recognition, acceleration detection, tile and/or movement detection, and the like.

According to one or more embodiments of the subject matter described herein, the detection of the user input at S110 may include detecting a series of clicks for selecting the plurality of content items. In some implementations, check boxes may be provided for respective content items to obtain the user's selections of corresponding content items. While being selected, the plurality of content items may be manipulated as a whole. By way of example, the selected plurality of content items may be shared or edited together, for example, via a desired application.

Alternatively or additionally, according to one or more embodiments of the subject matter described herein, the detection of the user input at S110 may include detecting movement of a pointing device for selecting the plurality of content items. In some implementations, a GUI may be controlled to switch from a navigating mode into a selecting mode, in which a user is enabled to select content items depending upon the movement of a pointing device.

Alternatively or additionally, according to one or more embodiments of the subject matter described herein, the detection of the user input at S110 may include detecting a user gesture for selecting the plurality of content items. In some implementations, a touch sensitive display and a potential display controller, along with any associated modules and/or sets of computing instructions in memory may detect a user gesture on the touch-sensitive display, for example, any movement or breaking of the contact on the touch-sensitive surface. The user gesture may be then converted into selections of the content items that are displayed on the touch-sensitive display. In other implementations, e.g., in a three dimensional (3D) GUI system, a user gesture may be detected by using 3D sensors and then converted into relevant inputting signal.

At S120, the method 100 determines a selection direction in which the plurality of content items are selected. According to one or more embodiments of the subject matter described herein, the selection direction of a user selection operation may be defined in different ways for different types of user input.

For example, in those embodiments where the user's selections include a series of clicks on the content items, the selection direction may be specified by a direction in which the series of clicks are performed. For example, in one embodiment, the cursor's relative positions or absolute coordinates on which the clicking events are detected can be recorded and compared with one another. As such, the selection direction of the clicks may be determined.

In those embodiments where the content items are selected by means of a pointing device, determining the selection direction at S120 may comprise determining a moving direction of the pointing device. For example, when the user makes the selection by means of the pointing device, the movement data (e.g., position coordinates and/or motion vectors) of the pointing device may be measured and then used to compute or estimate a moving direction of the pointing device.

In those embodiments where the selection of the content items is done by a user gesture, determining the selection direction at S120 may comprise determining a direction of the user gesture. For example, a touch-sensitive display or a 3D or multi-axis sensing system may be used to detect and recognize the user gesture, such that the movement data (for example, the position coordinates and/or motion vectors) of the user's hand, finger and/or other parts of the body may be measured and then used to estimate the direction of the user gesture.

Those skilled in the art may appreciate that in some cases the determined selection direction may be just an approximate representation of a direction, rather than an accurate directional parameter. For example, the selection direction may be a forward direction, a reverse direction, a top-to-bottom direction, a bottom-to-top direction, a right-to-left direction, a left-to-right direction, a direction in a predefined angle with a horizontal axis or a vertical axis, a clockwise direction, an anticlockwise direction, a direction substantially consistent with a direction of a predefined curve, and the like. Those skilled in the art may adopt any suitable technology or algorithm to obtain the approximate representation of the selection direction.

Upon determining the selection direction, it is determined whether the determined selection direction satisfies a predefined criterion. By way of example, in some embodiments, the predefined criterion for the selection direction may be any one or any suitable combination of the following criteria: the selection direction is from right to left; the selection direction is from bottom to top; the selection direction is in a predefined angle with a horizontal axis or a vertical axis; the selection direction is clockwise; the selection direction is anticlockwise; the selection direction is substantially consistent with a direction of a predefined curve; and the like. These examples are described only for the purpose of illustration, without suggesting any limitations as to the scope of the subject matter described herein. Any other additional or alternative criteria can be used as well.

In response to determining that the selection direction satisfies the predefined criterion, the method 100 proceeds to S130, where at least one functional item in a tool bar window is caused to be displayed for manipulating the selected plurality of content items. For example, once determining that the predefined criterion is satisfied, the tool bar window may be popped up on the display. The tool bar window contains one or more functional items associated with the selected content items. The term “functional item” as used herein may refer to a functional button/soft key, a shortcut icon of an application and any suitable functional user interface object that can activate an appropriate operation on the selected content items. In some implementations, the functional items contained in the tool bar window may be intelligently adjustable depending upon the selected content items and/or based on GUI configurations. The user may initiate a desired operation for all the selected content items by simply clicking the corresponding functional item rendered in the tool bar window.

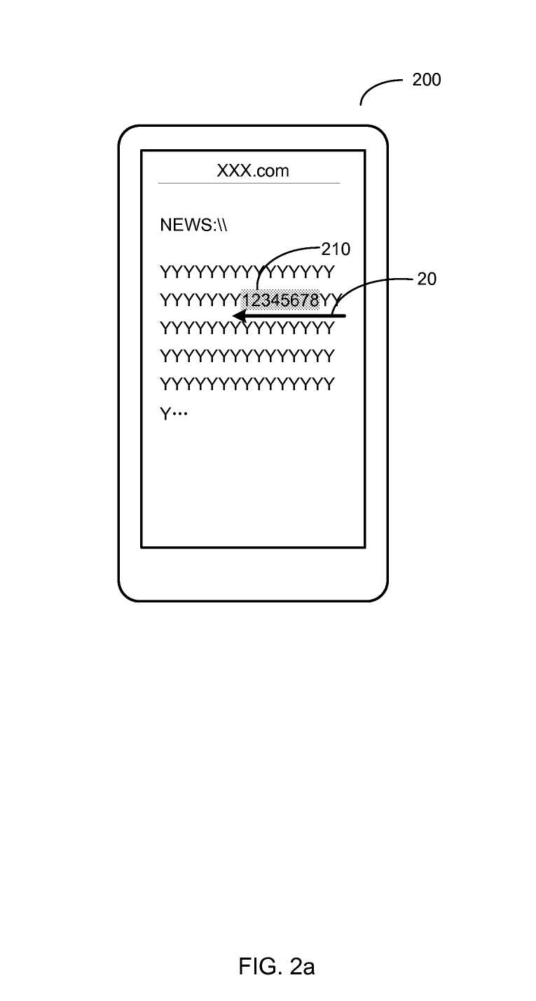

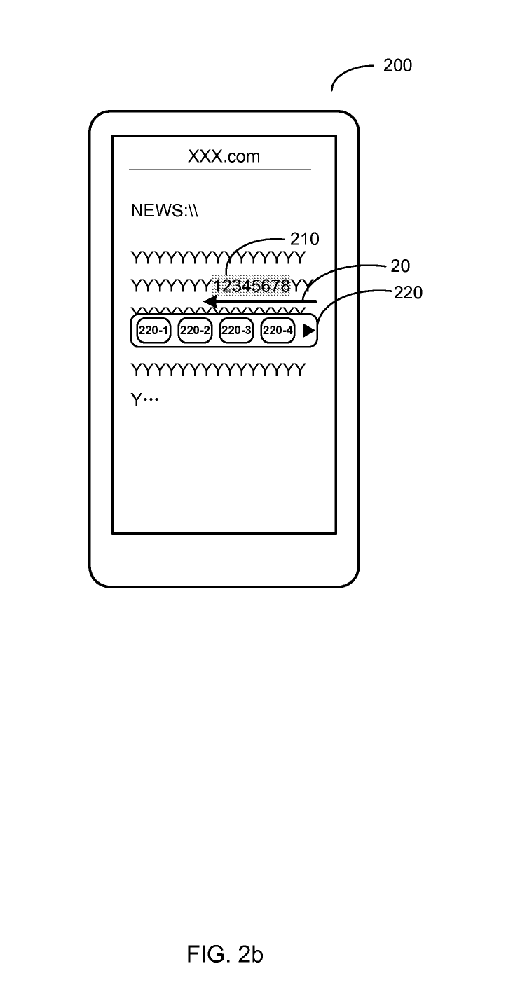

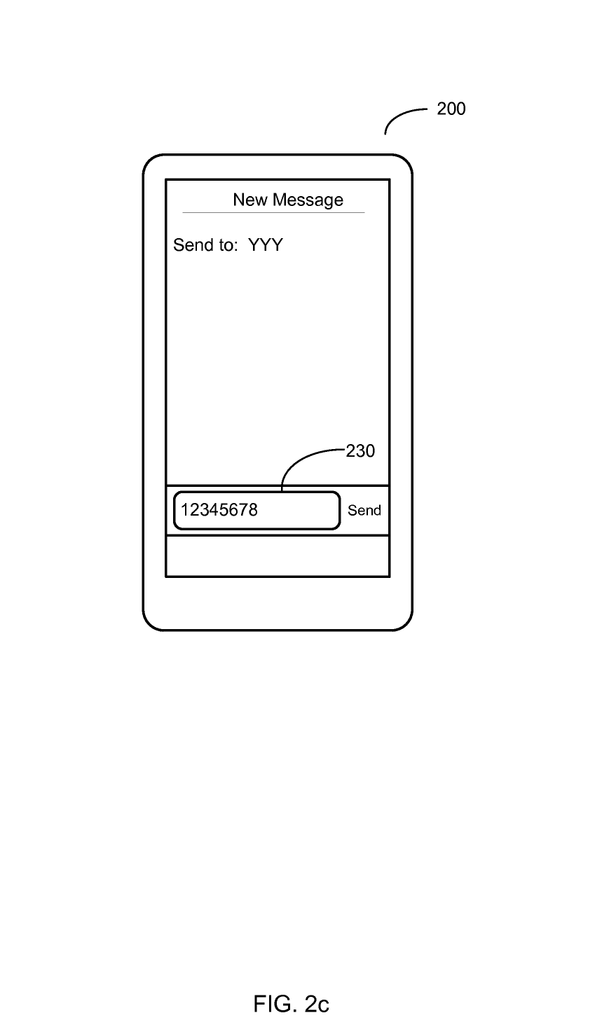

With reference to FIGS. 2a-2c, 3a-3c, 4a-4c, for the purpose of illustration and without suggesting any limitations as to the scope of the subject matter described herein, some specific example embodiments of the subject matter disclosed herein will now be discussed in detail.

FIGS. 2a-2c illustrate schematic diagrams showing a user interface 200 in accordance with one or more embodiments of the subject matter described herein.

As illustrated in FIG. 2a, there is depicted the user interface 200, by which a user is browning a web page including text contents. In response to a user operation selecting in a reverse direction (e.g., selecting in a right-to-left direction in this example, as illustrated by arrow 20), the selected text is highlight in a corresponding display area 210. In one example implementation, the selection input may be implemented by means of a pointing device, for example, a keyboard/keypad (e.g., Ctrl/Shift key plus arrow keys), a mouse, a trackball, a joystick, a roller, or a stylus or finger on a touch-sensitive display. Alternatively or additionally, in another example implementation, the selection input may be perform by means of an eye movement recognition system, an acceleration, tile and/or movement based input system, and the like.

In the example as discussed with reference FIG. 2a, it is supposed that the predefined criterion for triggering a tool bar window is that the selection direction is a right-to-left direction. Upon determining that the user operation selecting the text is performed in the right-to-left direction, the user interface 200 causes to display a tool bar window as denoted by reference numeral 220 in FIG. 2b.

Turning to FIG. 2b, the tool bar window 220 appears near the display area 210 and contains functional items 220-1, 220-2, 220-3, 220-4. Although in this example, only four functional items 220-1, 220-2, 220-3 and 220-4 are arranged in the horizontal tool bar, those skilled in the art would appreciate that more or fewer functional items may be arranged in any other suitable container of the user interface 200. For example, the tool bar window 220 may be implemented as a drop-down menu or a check list. Moreover, the location at which the tool bar window 220 may vary depending on the GUI's layout and/or the user's configuration.

The functional items 220-1, 220-2, 220-3 and 220-4 may correspond to potential operations to the selected text. In this example embodiment, the functional items 220-1 is a functional buttons for performing “Copy” operation, while the functional items 220-2, 220-3 and 220-4 are application icons for launching corresponding applications. For example, those applications may allow the user to edit, share, or perform any other desired operations on the selected text. For example, in one embodiment, the functional item 220-2 denotes a short message service (SMS) application icon, the functional item 220-3 denotes a text editor application icon, and the functional item 220-4 denotes a social network application icon. Although only one “Copy” button is depicted here to illustrate a functional button, those skilled in the art would appreciate that functional buttons for performing “Delete”, “Move”, “Paste” operations and the like may also be displayed in the tool bar window as need. Similarly, besides the SMS application icon, the text editor application icon and the social network application icon, as illustrated in FIG. 2b, any other suitable applications by which the user could manipulate the selected content items may also be displayed in the tool bar window for the user's selection.

FIG. 2c illustrates the user interface 200, which has been already switched into a GUI of the short message application after the user selects the short message application icon 220-2 shown in the tool bar window 220 as illustrated in FIG. 2b. The selected content item, namely, the text “12345678” as shown in FIG. 2b, has been automatically inserted into a message editing area 230 as a part of contents to be edited and sent in a SMS message. In this way, the user may have better experience, since there is no need to perform “Copy” and “Paste” operations, when he/she wants to send to his/her friend the content items via a SMS message.

Those skilled in the art would appreciate that although the example as discussed above only involves the text type of content items, the principle and concept of the embodiment may be applied to other types of content items or combinations thereof. For example, the user may select from the web page any combination of various content items (such as, but not limited to, text items, image items, items associated with audio or video clips and the like) in the right-to-left direction to trigger the display of the tool bar window. In this situation, the tool bar window may adaptively contain the functional items applicable for those selected content items.

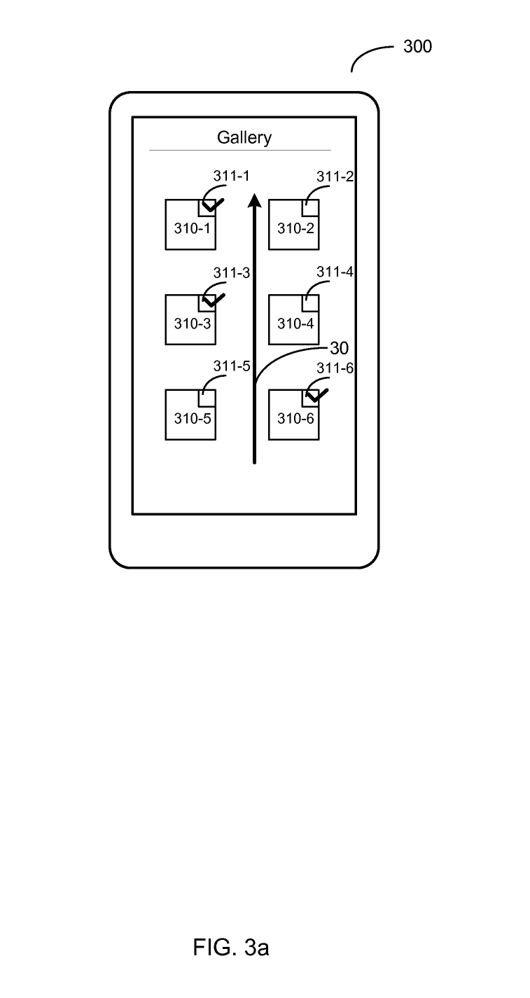

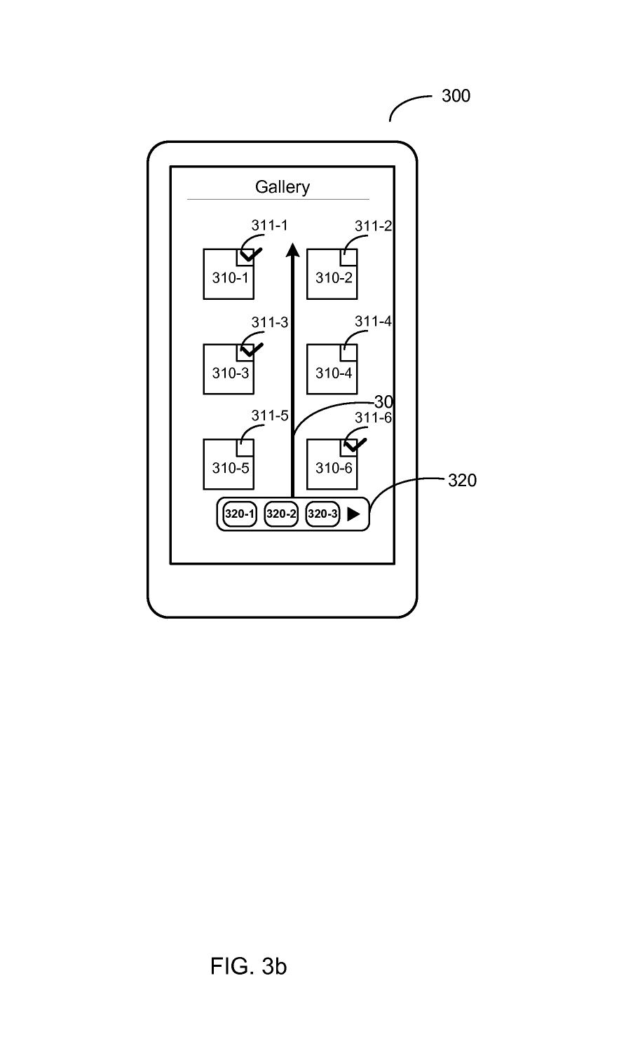

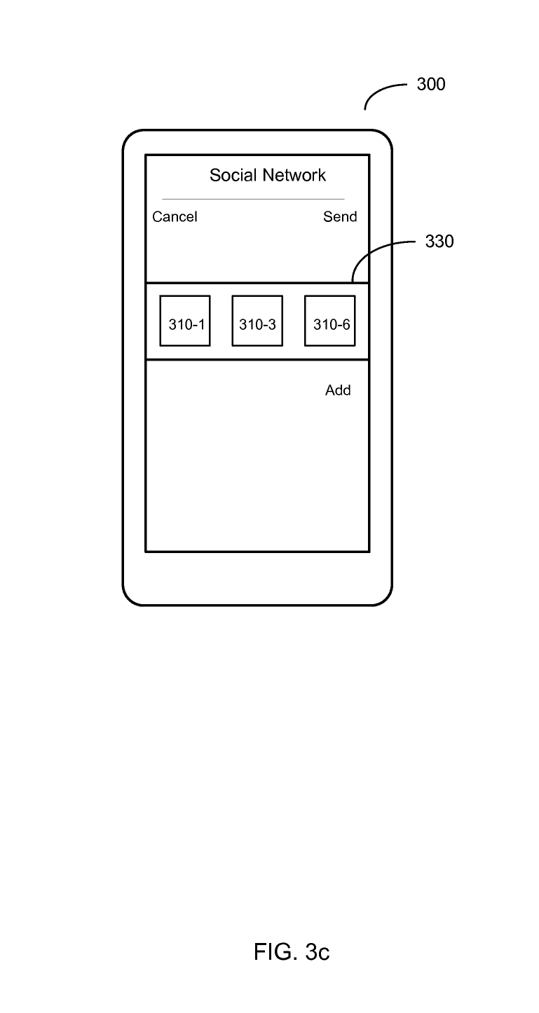

FIGS. 3a-3c illustrate schematic diagrams showing a user interface 300 in accordance with one or more embodiments of the subject matter described herein.

As illustrated in FIG. 3a, there is depicted the user interface 300, in which an image gallery application enters a selecting mode. In this mode, the image gallery application enables the user to mark up desired images by clicking the corresponding check boxes (for example, denoted by reference numerals 311-1, . . . , 311-6) for the thumbnails (for example, denoted by reference numerals 310-1, . . . , 310-6). In response to the clicking operations detected on the check boxes 311-3, 311-3 and 311-6, respectively, in a reverse selection direction (for example, a bottom-to-top direction in this example, as illustrated by arrow 30), the image thumbnails 310-1, 310-3 and 310-6 are labeled for further handling. In this example, it is supposed the predefined criterion triggering the popup of a tool bar window is that the selection direction is a bottom-to-top direction. In some implementations, the cursor's relative positions or absolute coordinates on which the clicking events are detected can be recorded. By comparing the recorded positions to one another, the selection direction may be determined. In case that the user's click operations are determined to be in a bottom-to-top direction, the user interface 300 may cause a tool bar window, as denoted by reference numeral 320 in FIG. 3b, to be displayed.

Turning to FIG. 3b, the tool bar window 320 may be a tool bar which contains functional items 320-1, 320-2 and 320-3. Although only three functional items 320-1, 320-2, 320-3 are arranged in the horizontal tool bar 320, those skilled in the art can appreciate that more or fewer functional items may also be arranged in any other suitable container of the user interface 300, for example, a drop-down menu or a check list. The functional items 320-1, 320-2 and 320-3 may correspond to the potential operations applicable to the selected images. In this example embodiment, the functional item 320-1 is a functional buttons for performing “Copy” operation, while the functional items 320-2 and 320-3 are application icons for launching corresponding applications for editing and/or sharing the selected images. For example, in one embodiment, the functional item 320-2 denotes an image editor application icon, and the functional item 320-3 denotes a social network application icon. Although only one “Copy” button is depicted here to illustrate a functional button, those skilled in the art would appreciate that functional buttons for performing “Delete”, “Move”, “Paste” operations and the like may also be displayed in the tool bar window as need. Similarly, besides the image editor application icon and the social network application icon, as illustrated in FIG. 3b, any other suitable applications by which the user could manipulate the selected content items may also be displayed in the tool bar window for the user's selection.

FIG. 3c illustrates the user interface 300, which has been already switched into a GUI of the social network application after the user selects the social network application icon 320-3 shown in the tool bar window 320 as illustrated in FIG. 3b. The corresponding social network application can be automatically launched, in response to the user operation of selecting the application icon 320-3. The representations of the selected images may be loaded into a display area 330 and ready for sharing with the user's friends. In this way, the user may have better experience, since there is no need to do those cumbersome operations, such as opening the social network application and upload the desired images one by one.

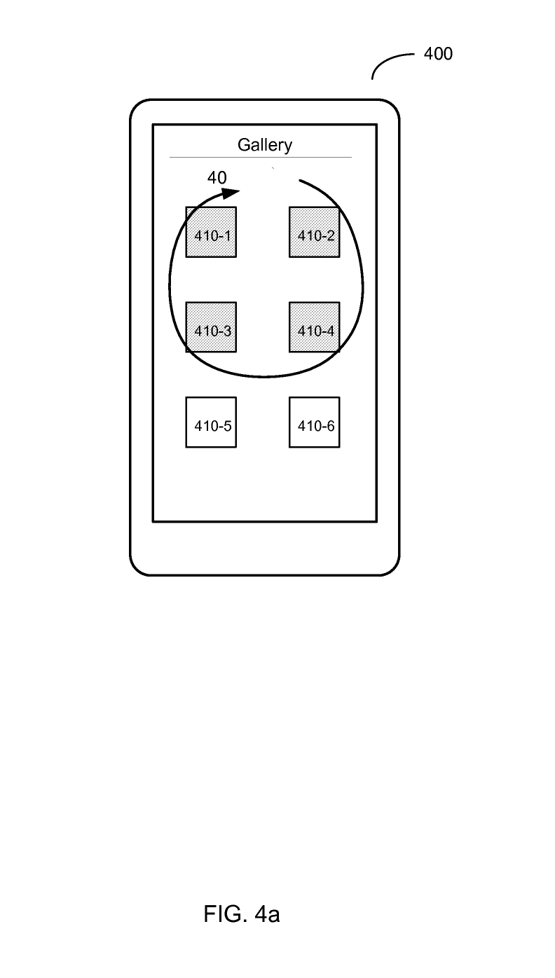

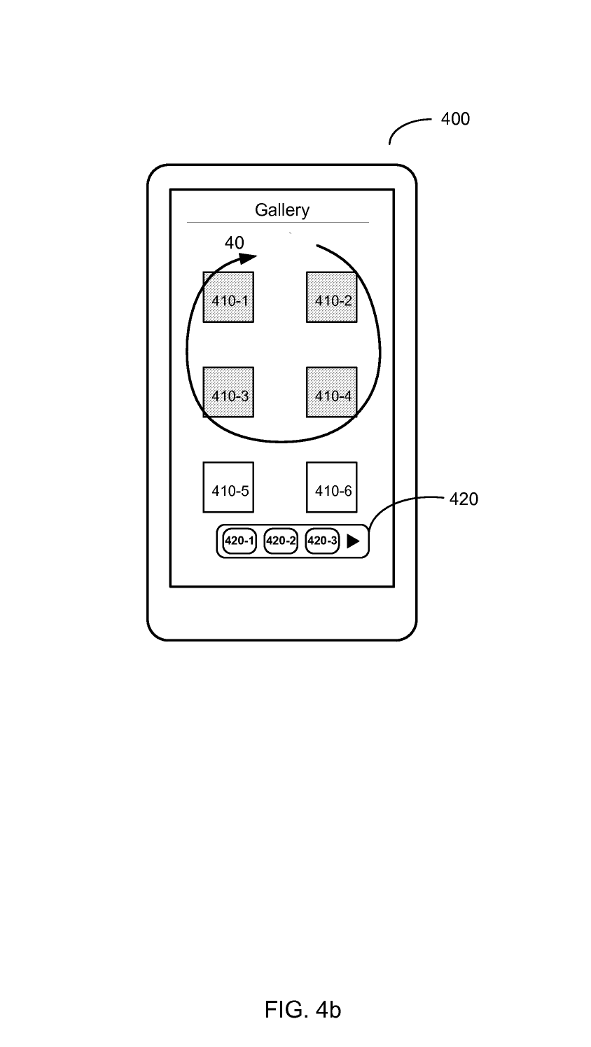

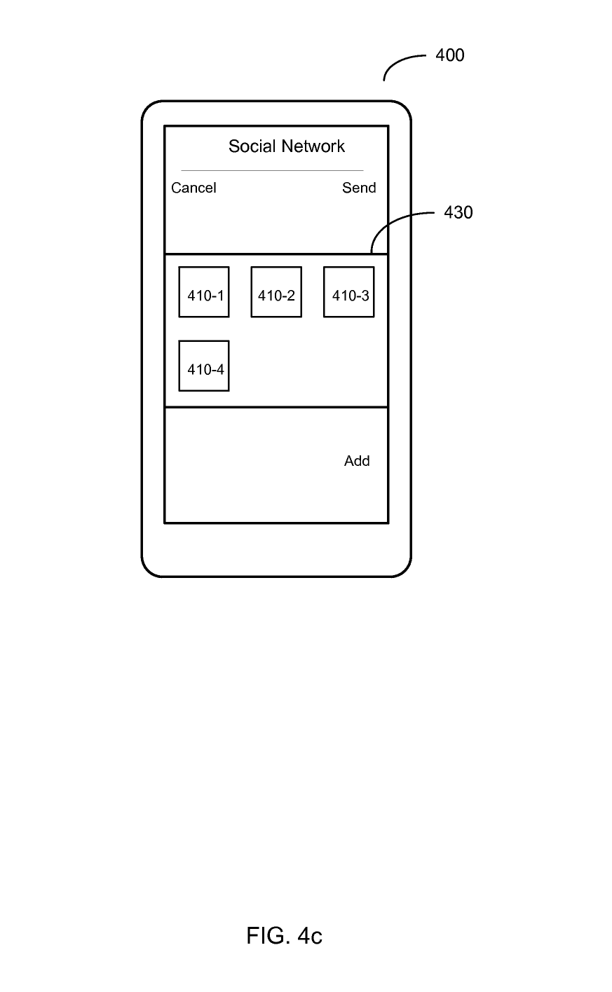

FIGS. 4a-4c illustrate schematic diagrams showing a user interface 400 in accordance with one or more embodiments of the subject matter described herein.

As illustrated in FIG. 4a, there is depicted the user interface 400, by which an image gallery application enters a selecting mode. In this mode, the image gallery application enables the user to select desired images by moving a pointing device or performing a user gesture. For example, the content items that are enclosed by a trace resulted from the user gesture may be selected. For the sake of discussion, it is supposed that the user moves the pointing device or performs a user gesture in a direction as illustrated by the arrow 40 in FIG. 4a. In response, the image thumbnails 410-1, 410-2, 410-4 and 410-5 enclosed in the resulting clockwise trace are selected and highlighted for further handling. In this example, it is supposed that the predefined criterion triggering the popup of a tool bar window is that the selection direction is a clockwise direction. Upon determining the movement of the pointing device or the user gesture in the clockwise direction, the user interface 400 causes to display a tool bar window as denoted by reference numeral 420 in FIG. 4b. It will be appreciated that although the example provided involves the criterion that the selection direction is clockwise, the concept described herein also applies to any other suitable criterion. For example, it is possible to specify that an anticlockwise moving direction or a bottom-to-top moving direction of the pointing device could trigger the tool bar window. Furthermore, although the trace is illustrated as circuitry in FIG. 4a, those skilled in the art would appreciate that the specific form or appearance of the resulted trace should not be construed as any limitations to the scope of the subject matter described herein. In some other example embodiments, the resulted trace may be in form of, but not limited to a trace with a particular angle, a trace with orthogonal lines, a trace with parallel lines, a trace with a pre-designed curve, and the like.

Turning to FIG. 4b, the tool bar window 420 may be a tool bar which contains functional items 420-1, 420-2 and 420-3. Similar to FIG. 3b, in this example embodiment, the functional item 420-1 is a functional buttons for performing “Copy” operation, while the functional items 420-2 and 420-3 are application icons for launching corresponding applications allowing image editing or sharing. For example, in one embodiment, the functional item 420-2 denotes an image editor application icon, and the functional item 420-3 denotes a social network application icon. Although only one “Copy” button is depicted here to illustrate a functional button, those skilled in the art would appreciate that functional buttons for performing “Delete”, “Move”, “Paste” operations and the like may also be displayed in the tool bar window as need. Similarly, besides the image editor application icon and the social network application icon, as illustrated in FIG. 4b, any other suitable applications by which the user could manipulate the selected content items may also be displayed in the tool bar window for the user's selection.

FIG. 4c illustrates the user interface 400, which has been already switched into a GUI of the social network application after the user selects the social network application icon 420-3 shown in the tool bar window 420 as illustrated in FIG. 4b. Similar to FIG. 3c, the corresponding social network application can be automatically launched in response to the user operation of selecting the application icon 420-3, with the representations of the selected images being loaded into a display area 430 and ready for sharing with the user's friends. As such, the user may have better experience due to the simplification of the operations.

It would be appreciated that in addition to or instead of the predefined criteria as described with reference to FIGS. 2a-2c, 3a-3c and 4a-4c, any other suitable criteria can be combined with one another to determine whether to trigger the tool bar window. For example, in the embodiment as illustrated FIGS. 4a-4c, in addition to or instead of the clockwise selection direction, it may be further predefined that the selection operations of moving the pointing device or performing a user gesture in a bottom-to-top and/or right-to-left direction can trigger the presentation of the tool bar window. In this regard, those skilled in the art may make any modifications to the embodiments as described herein without departing the concept of the present disclosure.

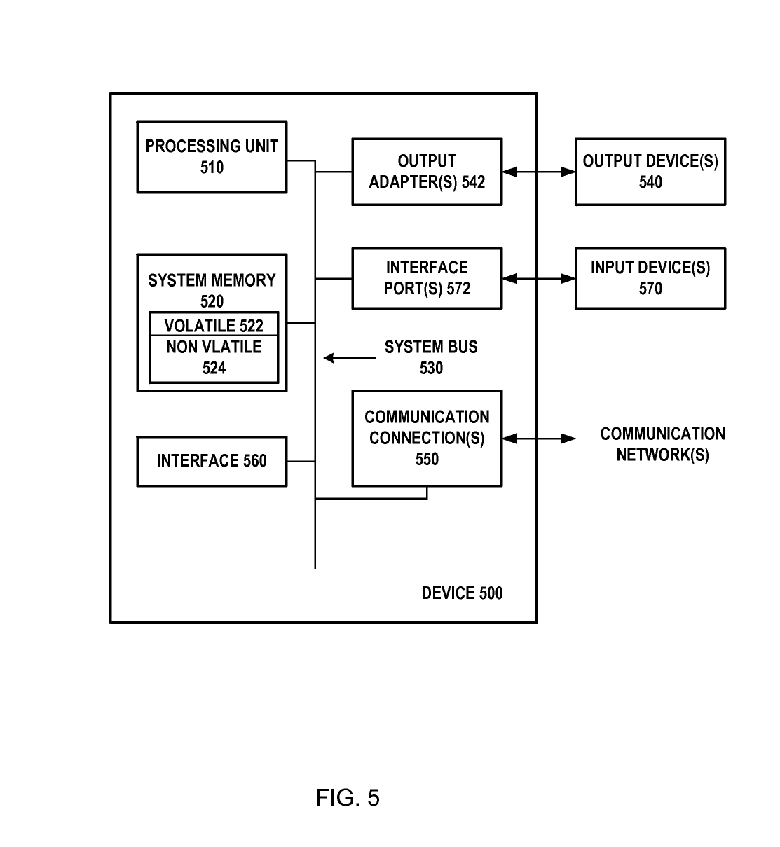

FIG. 5 illustrates a block diagram of a device in accordance with one embodiment of the subject matter described herein.

In order to provide context for various aspects of the subject matter disclosed herein, FIG. 5 and the following discussion are intended to provide a brief general description of a device 500 with a suitable computing environment in which various embodiments of the subject matter disclosed herein may be implemented.

While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The device 500 is only one example of a suitable operating device and is not intended to limit the scope of use or functionality of the subject matter disclosed herein.

With reference to FIG. 5, the device 500 may include at least one processing unit 510, a system memory 520, and a system bus 530. The at least one processing unit 510 can execute instructions that are stored in a memory such as but not limited to system memory 520. The processing unit 510 can be any of various available processors. For example, the processing unit 510 can be a graphics processing unit. The instructions can be instructions for implementing functionality carried out by one or more components or modules discussed above or instructions for implementing one or more of the methods described above. Dual microprocessors and other multiprocessor architectures also can be employed as the processing unit 510. The device 500 may be used in a system that supports rendering graphics on a display screen. In another example, at least a portion of the device can be used in a system that comprises a graphical processing unit. The system memory 520 may include volatile memory 522 and nonvolatile memory 524. Nonvolatile memory 524 can include read only memory (ROM), programmable ROM (PROM), electrically programmable ROM (EPROM) or flash memory. Volatile memory 522 may include random access memory (RAM) which may act as external cache memory. The system bus 530 couples system physical artifacts including the system memory 520 to the processing unit 510. The system bus 530 can be any of several types including a memory bus, memory controller, peripheral bus, external bus, or local bus and may use any variety of available bus architectures. The device 500 may include a data store (not shown) accessible by the processing unit 510 by way of the system bus 530. The data store may include executable instructions, 3D models, materials, textures and so on for graphics rendering.

The device 500 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by the device 500. Communications media include media such as, but not limited to, communications signals, modulated carrier waves or any other intangible media which can be used to communicate the desired information and which can be accessed by the device 500.

It will be appreciated that FIG. 5 describes software that can act as an intermediary between users and computer resources. This software may include an operating system which can be stored on disk storage (not shown), and which can allocate resources of the device 500. Disk storage may be a hard disk drive connected to the system bus 530 through a non-removable memory interface such as interface 560. System applications take advantage of the management of resources by operating system through program modules and program data stored either in system memory 520 or on disk storage. It will be appreciated that computers can be implemented with various operating systems or combinations of operating systems.

A user can enter commands or information into the device 500 through an input device(s) 570. Input devices 570 include but are not limited to a pointing device such as a mouse, trackball, stylus, touch pad, keyboard, microphone, voice recognition and gesture recognition systems and the like. These and other input devices connect to the processing unit 510 through the system bus 530 via interface port(s) 572. The interface port(s) 572 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 530. Other devices and/or systems or devices such as remote computer(s) (not shown) may provide both input and output capabilities.

The device 500 can operate in a networked environment using logical connections to one or more remote computers, such as a remote computer(s), for example, a personal computer, a server, a router, a network PC, a peer device or other common network node. Remote computer(s) can be logically connected via communication connection(s) 550 of the device 500, which supports communications with communication networks such as local area networks (LANs) and wide area networks (WANs) but may also include other networks. Communication connection(s) 550 may be internal to or external to the device 500 and include internal and external technologies such as modems (telephone, cable, DSL and wireless) and ISDN adapters, Ethernet cards and so on. It will be appreciated that the network connections described are examples only and other means of establishing a communications link between the computers may be used.

Generally, various embodiments of the subject matter described herein may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the subject matter described herein are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

By way of example, embodiments of the subject matter can be described in the general context of machine-executable instructions, such as those included in program modules, being executed in a device on a target real or virtual processor. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the subject matter described herein may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of this disclosure, a machine readable medium may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of facilitating manipulation of content items, comprising:
detecting a user input for selecting a plurality of content items;
determining a selection direction in which the plurality of content items are selected; and
in response to determining that the selection direction satisfies a predefined criterion, causing at least one functional item in a tool bar window to be displayed for manipulating the selected plurality of content items.

2. The method of claim 1, wherein detecting the user input comprises detecting a series of clicks for selecting the plurality of content items, wherein the selection direction is specified by a direction in which the series of clicks are performed.

3. The method of claim 1, wherein detecting the user input comprises detecting movement of a pointing device for selecting the plurality of content items,
and wherein determining the selection direction comprises determining a moving direction of the pointing device.

4. The method of claim 1, wherein detecting the user input comprises detecting a user gesture for selecting the plurality of content items,
and wherein determining the selection direction comprises determining a direction of the user gesture.

5. The method of claim 2, wherein the predefined criterion includes at least one of following criteria:
the selection direction is from right to left;
the selection direction is from bottom to top; or
the selection direction is in a predefined angle with a horizontal axis or a vertical axis.

6. The method of claim 3, wherein the predefined criterion includes at least one of following criteria:
the selection direction is from right to left;
the selection direction is from bottom to top;
the selection direction is in a predefined angle with a horizontal axis or a vertical axis;
the selection direction is clockwise;
the selection direction is anticlockwise; or
the selection direction is substantially consistent with a direction of a predefined curve.

7. The method of claim 1, wherein the at least functional item includes an application icon, the method further comprising:
launching, in response to detecting a selection of an application icon on the tool bar, a corresponding application to manipulate the selected plurality of content items.

8. An apparatus for facilitating manipulation of content items, comprising:
at least one processor; and
at least one memory including computer program instructions;
wherein the at least one memory and computer program instructions are configured to, with the at least one processor, cause the apparatus at least to:
detect user input for selecting a plurality of content items;
determine a selection direction in which the plurality of content items are selected; and
in response to determining that the selection direction satisfies a predefined criterion, cause to display at least one functional item in a tool bar window for manipulating the selected plurality of content items.

9. The apparatus of claim 8, wherein detecting the user input comprises detecting a series of clicks for selecting the plurality of content items, wherein the selection direction is specified by a direction in which the series of clicks are performed.

10. The apparatus of claim 8, wherein detecting the user input comprises detecting movement of a pointing device for selecting the plurality of content items, wherein the selection direction is specified by a moving direction of the pointing device.

11. The apparatus of claim 8, wherein detecting the user input comprises detecting a user gesture for selecting the plurality of content items, where the selection direction is specified by a direction of the user gesture.

12. The apparatus of claim 9, wherein the predefined criterion is any one or any combination of following criteria that:
the selection direction is from right to left;
the selection direction is from bottom to top; or
the selection direction is in a predefined angle with a horizontal axis or a vertical axis.

13. The apparatus of claim 10, wherein the predefined criterion is any one or any combination of following criteria that:
the selection direction is from right to left;
the selection direction is from bottom to top;
the selection direction is in a predefined angle with a horizontal axis or a vertical axis;
the selection direction is clockwise;
the selection direction is anticlockwise; or
the selection direction is substantially consistent with a direction of a predefined curve.

14. The apparatus of claim 8, wherein the at least functional item includes an application icon,
and wherein the at least one memory and computer program instructions are configured to, with the at least one processor, cause the apparatus at least to:
launch, in response to detecting a selection of the application icon in the tool bar window, a corresponding application to manipulate the selected plurality of content items.

15. A method of facilitating manipulation of content items, comprising:
detecting user input for selecting a plurality of content items;
determining a selection direction in which the plurality of content items are selected;
in response to determining that the selection direction satisfies a predefined criterion, causing to display a tool bar window containing at least one application icon;
detecting a selection of the application icon in the tool bar window; and
launching an application corresponding to the selected application icon to manipulate the selected plurality of content items.

16. The method of claim 15, wherein receiving the user input comprises detecting a series of clicks for selecting the plurality of content items,
and wherein determining the selection direction comprises determining a direction in which the series of clicks are performed.

17. The method of claim 15, wherein receiving the user input comprises detecting movement of a pointing device for selecting the plurality of content items,
and wherein the selection direction comprises determining a moving direction of the pointing device.

18. The method of claim 15, wherein receiving the user input comprises detecting a user gesture for selecting the plurality of content items,
and wherein determining the selection direction comprises determining a direction of the user gesture.

19. The method of claim 16, wherein the predefined criterion is any one or any combination of following criteria that:
the selection direction is from right to left;
the selection direction is from bottom to top; or
the selection direction is in a predefined angle with a horizontal axis or a vertical axis.

20. The method of claim 17, wherein the predefined criterion is any one or any combination of following criteria that:
the selection direction is from right to left;
the selection direction is from bottom to top;
the selection direction is in a predefined angle with a horizontal axis or a vertical axis;
the selection direction is clockwise;
the selection direction is anticlockwise; or
the selection direction is substantially consistent with a direction of a predefined curve.
